(19) United States
(12) Patent Application Publication
(10) Pub. No.: US 2008/0098309 A1
(43) Pub. Date: Apr. 24, 2008

(54) Managing virtual machines and hosts by property

(75) Inventors: Robert M. Fries, Kirkland, WA (US); Michael Michael, Redmond, WA (US); Eric Winner, Woodinville, WA (US); Bill Scheidel, Seattle, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 11/586,155

(22) Filed: Oct. 24, 2006

(51) Int. Cl. G06F 9/455

(52) U.S. Cl. 715/734; 718/1

(57) ABSTRACT

Virtual machines and hosts of virtual machines are dynamically organized and managed in accordance with specific properties of the virtual machines and hosts. A system can be browsed for virtual machines/hosts having a specific property(s). Properties and property values are represented by a hierarchical structure of folders and subfolders, and/or in a textual hierarchical directory structure. Selection of a property value results in the virtual machines/hosts having the selected property value attributed thereto. Browsing can also be accomplished via a hierarchical textual directory structure. A virtual machine can be selected to navigate the virtual and view its constituents. Properties, property values, virtual machines, and hosts can be added, deleted, and/or modified.

### TECHNICAL FIELD

The technical field is generally related to computer processing and more specifically relates to managing virtual machines.

### BACKGROUND

To aid in the management of virtual machines (VMs) and hosts, which could be thousands in number, it is not uncommon for system administrators, or the like, to create a hierarchical structure of groups into which the hosts (and thus the virtual machines) can be placed. By depicting where hosts and VMs were placed, this organization structure provides a mechanism for accessing a particular host or VM. This mechanism does not, however, provide a means for readily depicting properties of the hosts and VMs. Thus, searching for a host or VM having a specific property can be time consuming, tedious, and error prone.

### SUMMARY

This Summary is provided to introduce a selection of concepts in a simplified form that are further described below in the Detailed Description Of Illustrative Embodiments. This Summary is not intended to identify key features or essential features of the claimed subject matter, nor is it intended to be used to limit the scope of the claimed subject matter.

Virtual machines and hosts of virtual machines are dynamically organized based on specific properties of the virtual machines/hosts. In an example embodiment, virtual machines/hosts are depicted as icons in a hierarchical structure representing folders and subfolders. The folders and subfolders are renderable by property. The folder and subfolders are browsable by property. For example, a system can be queried for virtual machines/hosts having properties such as the geographical location of a virtual machine/host, whether a virtual machine/host has been installed, whether a virtual machine/host has been updated, if a virtual machine/host is running, if a virtual machine is paused, if a virtual machine is stopped, or the like. The results of such a query are rendered in a hierarchical structure comprising folders and subfolders indicating the status of the queried property. Properties can be added, deleted, and modified. Custom properties can be added. The ordering and organizing of folders and subfolders for rendering can be specified.

### BRIEF DESCRIPTION OF THE DRAWINGS

The foregoing summary, as well as the following detailed description, is better understood when read in conjunction with the appended drawings. For the purpose of illustrating the management of virtual machines and hosts by property, there is shown in the drawings exemplary constructions thereof, however, managing virtual machines and hosts by property is not limited to the specific methods and instrumentalities disclosed.

FIG. 1 is an illustration an example graphical user interface (GUI) rendering of a hierarchical structure of folders and subfolders representing properties and property values attributable to a virtual machine.

FIG. 2 is a continuation of FIG. 1.

FIG. 3 is illustrates a rendering of an example textual hierarchical directory structure.

FIG. 4 is a continuation of FIG. 3.

FIG. 5 is an illustration of an example rendering of a folder representing the various properties and virtual machines.

FIG. 6 is a rendering of an example textual hierarchical directory structure showing components of virtual machines.

FIG. 7 is an illustration of a GUI rendering of example constituents of a virtual machine.

FIG. 8 is an illustration of a GUI rendering of example files comprising a virtual machine from a host server perspective.

FIG. 9 is a depiction of a rendering of an example textual hierarchical directory structure of a registry.

FIG. 10 is a depiction of a GUI rendering of a registry.

FIG. 11 is an example textual hierarchical directory structure rendering of devices of a virtual machine.

FIG. 12 is an example GUI rendering of devices of a virtual machine.

FIG. 13 is a flow diagram of an example process for managing a virtual machine by property.

FIG. 14 is an example computing environment for managing virtual machines and hosts by property.

### DETAILED DESCRIPTION OF ILLUSTRATIVE EMBODIMENTS

In accordance with managing virtual machines and hosts by property, a system can be browsed for virtual machines (VMs) and/or hosts on which a virtual machine resides having a specific property, or properties. The visual rendering of “by property” browsing, in an example embodiment, comprises a folder for the selected group of properties wherein the sub-folders of that folder represent the unique property values. By selecting a property value, all the hosts/VMs that match the selected property value, are rendered. This rendering provides a fast and easily navigable hierarchical view of the hosts/VMs and properties associated therewith. In another example embodiment, the visual rendering of by property browsing comprises a textual directory structure of properties and property values.

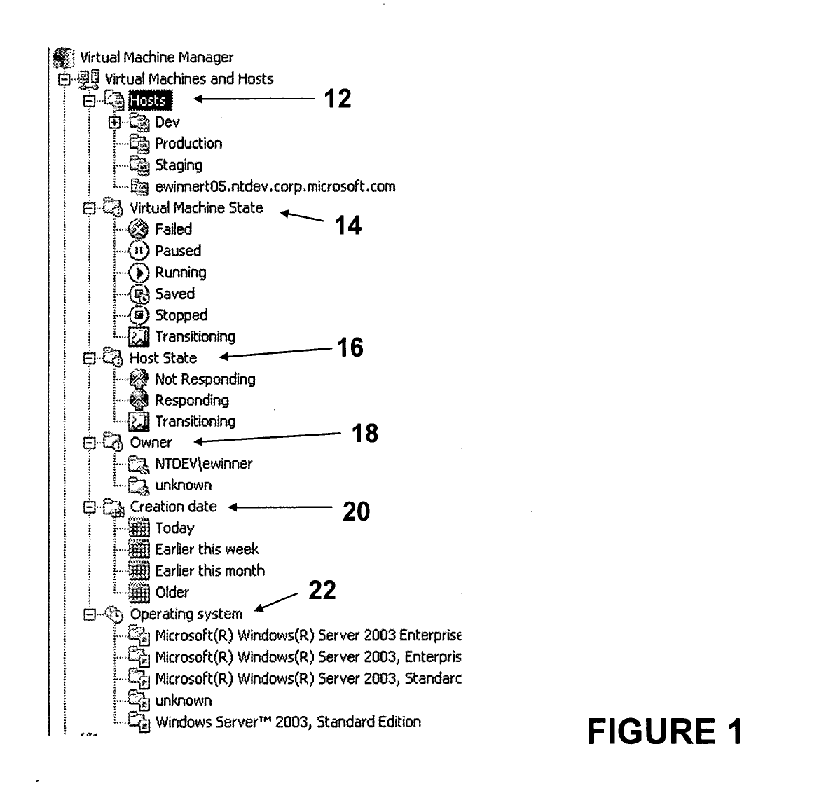

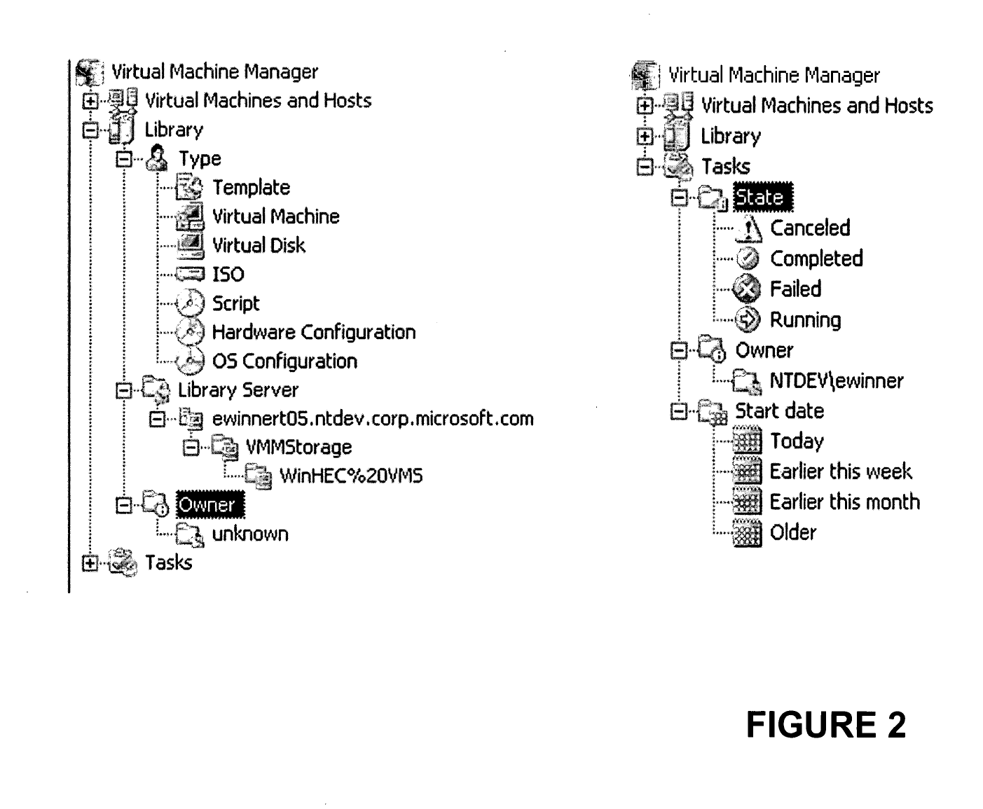

FIG. 1 and FIG. 2 illustrate an example graphical user interface (GUI) rendering of a hierarchical structure of folders and subfolders representing properties and property values attributable to a virtual machine and host. For the sake of simplicity, the herein description is with respect to FIG. 1, with the understanding that the description also appropriately applies to FIG. 2. FIG. 1 depicts the properties of “Hosts” 12, “Virtual Machine State” 14, “Host State” 16, “Owner” 18, “Creation Date” 20, and “Operating System” 22 In an example embodiment, the properties comprise user-defined and/or system-defined custom hierarchical properties. For example, as depicted in FIG. 1, the hosts are organized by department and host allocation (e.g., host in production or test host). Each property value of a property is represented by a subfolder. As depicted in FIG. 1, each folder and subfolder is represented by an icon. It is to be understood, however, that rendering icons is optional, and the hierarchical structure depicted in FIG. 1 and FIG. 2 is not limited thereto. It is to be understood that the properties and property values depicted in FIG. 1 and FIG. 2 are exemplary and should not be limited thereto. For example, a property of “Location” indicative of a geographic location of a virtual machine or a host is applicable, but not depicted in FIG. 1 or FIG. 2.

The Host folder 12 represents a property attributable to a host. The properties values of the Host property 12 comprise specific types of hosts. For example, the property values depicted in FIG. 1 are: Development (Dev), Production, Staging, and ewinnert05.ntdev.corp.microsoft.com (ewinnert05 is a name of a host). Each property value is represented by a subfolder. Hosts can be organized by property or, optionally, hosts can be rendered as a simple list (e.g., name of host) having no associated properties shown. For example, as depicted in FIG. 1 and FIG. 2, ewinnert05 is an example name of a host having the property of host, with no property matching the hierarchical structure depicted. The “Virtual Machine State” folder 14 represents another property attributable to a virtual machine. The property value “Virtual Machine State” 14 is indicative of the state of a virtual machine. As depicted in FIG. 1, the property “Virtual Machine State” 14 can have the property value of Failed, Paused, Running, Saved, Stopped, or Transitioning. It is to be understood that the property values depicted in FIG. 1 and FIG. 2 are exemplary, and that more or less property values can be assigned/rendered. The property value “Host State” 16 is indicative of the state of a host on which a virtual machine resides. The “Host State” property 16 can have the property value of Not Responding, Responding, or Transitioning. The “Owner” property 18 is indicative of the owner of a virtual machine. The “Owner” property 18 can have the property value of NTDEV/ewinner and unknown. For example, anything that does not fall within ntdev\ewinner and does not have its own property value can be categorized in other default or system assignments such as unknown. The names of the host type are exemplary. Hosts can be organized in any appropriate manner. For example, a system administrator, or the like, can generate multiple folders to organize hosts by location, by type of host, and/or by the workload of the host. As depicted in FIG. 1 and FIG. 2, the names organize the host by the role of a respective host, such as a production host in which its VMs are all running critical applications, or a Staging host in which VMs are close to being production quality. The “Operating system” property 22 is indicative of the operating system under which a virtual machine operates. The “Operating system” property 22 can have the property value of any appropriate operating system.

In an example embodiment, the hierarchical structure depicted in FIG. 1 can be used to browse a system for virtual machines and/or hosts having a specific property and/or property value. Selecting a property value results in a rendering of all virtual machines or all hosts in the system having the selected property value attributed thereto. For example, selecting the “Dev” subfolder under the “Hosts” property 12 folder will result in a rendering of all development hosts, and/or the rendering of additional properties that have the Dev subfolder as a parent. Thus, a subfolder can host other subfolders in the hierarchy. A development host is a host on which a virtual machine is being developed. In this example, as is known, the “Dev” subfolder can be selected, via a mouse, by double clicking or right clicking and opening the “Dev” subfolder. Upon selecting a property value, virtual machines or hosts having the selected property attributed thereto can be rendered in any appropriate manner. For example, continuing with the above example scenario, selecting the “Dev” subfolder can result in the host having virtual machines under development being rendered under the “Dev” subfolder. And, to illustrate the hierarchical structure, the list of hosts having virtual machines under development can be indented accordingly under the “Dev” subfolder.

In an example embodiment, properties can be assigned to a virtual machine and/or host utilizing the hierarchical structure depicted in FIG. 1. For example, a system administrator, or the like, can select a property value and assign the selected property value to the appropriate virtual machine or host. A system administrator, or the like, can also create new property values and/or custom properties and assign those to VMs. Further, properties, property values, virtual machines, and hosts can be added, deleted, and/or modified. Search folders, objects (folders and subfolders) in the hierarchical structure are marked to indicate if various object properties are navigable by property or not navigable. This setting controls whether a node for a property appears in the tree. Custom properties added to the object appear in this same list and also are navigable properties. In an example embodiment, custom hierarchies can be defined. A custom hierarchy provides the ability to navigate a system in accordance with the custom hierarchy, thus allowing a user to efficiently drill into the system in any of a variety of paths.

For properties that can be browsed, in an example embodiment, a tree-node is generated. In an example embodiment, sub-nodes of the tree-node can comprise a fixed set of known values, a set of values based on a current system configuration, and/or groups of values. For the fixed set of known values a complete set of tree of sub-nodes is generated, some of which may contain no resulting virtual machines, hosts, library objects, tasks, or the like. For example, for a property of “State” or “Task,” sub-nodes of Running, Stopped, Paused, Canceled, or the like, are generated regardless of the current values in the system. Further, nodes can be dynamically generated based on existing objects matching this state/property. For the sub-node comprising a set of values based on the current state of the system, a set of sub-nodes is generated indicative of the unique set of values which currently exist in the system. When a new value is entered into the system, a respective new sub-node is generated. For example, with respect to the property of “Owner” property, when a first person installs and runs the system, all objects are owned by that one person and the single sub-node to Owner is that person. As more people interact with the system and create objects, virtual machines, and/or tasks, more sub-nodes are generated for the “Owner” node. For groups of values (e.g., dates), groups of sub-nodes are generated in which the property has the value greater than a certain threshold and less than a threshold. Date fields can have an extremely large possible data set. For day to day operations, the most recent date is often the most applicable. Thus, for dates, values are grouped into a selected list of sub-folders with one of the folders representing everything “older” than a certain date. For example, for the property of “Creation Date,” subfolders of Today, Earlier this week, Earlier this month, and Older, are generated. It is to be understood that the date folders described are exemplary, and that more or less date search folder can be generated. Further, search results can be saved in a designated folder (e.g., folder having a property “Search Results”). For example, if a user in a GUI selected all VMs that have the state=running, and then the user performed a search based on another custom property, the user can save this custom search as a unique, by attribute, folder. Then, if the user would like to find the same VMs again based on the user's custom requirement, the user can easily visit the newly created folder for the search results.

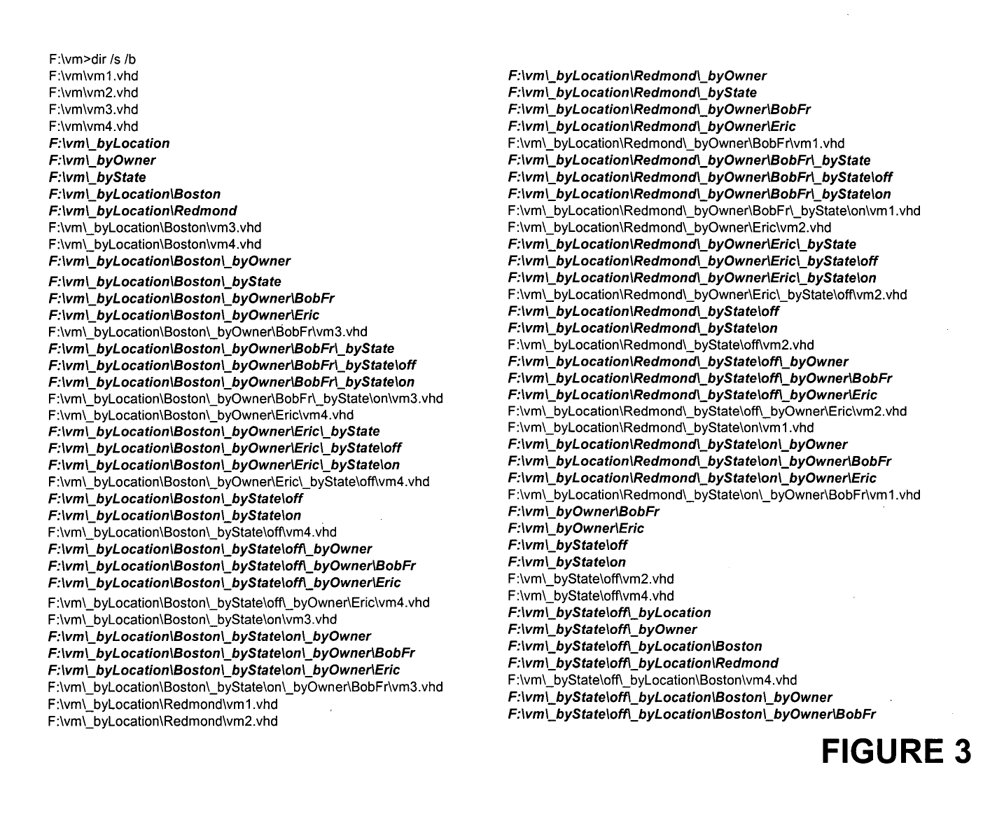

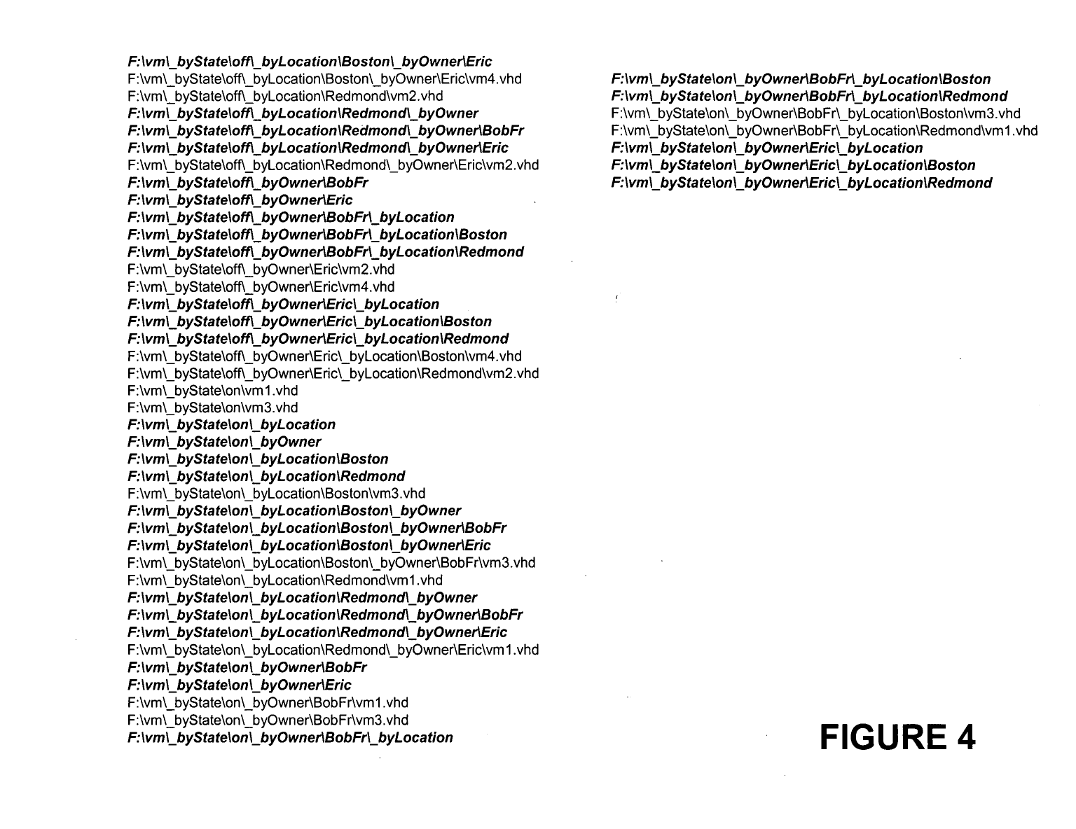

In another example embodiment, the visual rendering of “by property” browsing comprises a textual hierarchical directory structure. FIG. 3 and FIG. 4 illustrate a rendering of an example textual hierarchical directory structure that a user can encounter when navigating a hierarchy from a command-line interface. FIG. 3 and FIG. 4 represent a listing of a hierarchical directory structure wherein a system comprises four virtual machines having the following properties. This hierarchical structure is browsable by property as described above with respect to the GUI examples described above.

Name=vm1.vhd, Location=Redmond, Owner=BobFr, State=On

Name=vm2.vhd, Location=Redmond, Owner=Eric, State=Off

Name=vm3.vhd, Location=Boston, Owner=BobFr, State=On

Name=vm4.vhd, Location=Boston, Owner=Eric, State=Off

In FIG. 3 and FIG. 4, directories are emphasized in italics and bold font. Further, the directory structure depicted represents links to single instances of each virtual machine in the directory. In an example embodiment, a directory command is executed to query for a virtual machine or a host having attributed thereto a specific property value. For example, the following command line can be entered to query for all virtual machines having attributed thereto the property of “State” and the property value on (e.g., a query for all virtual machines that are currently on or running).

Dir_byState\on\*.vhd

### Note that a .vhd file (virtual hard drive) is one of the files representing a VM. A VM also can be represented by a .vmc file (i.e., a virtual machine configuration file).

In another example, the following command line can be entered to query for all virtual machines having the property of “State” with the property value of On, and the property of “Owner” with the property value of Bobfr (e.g., query for all virtual machines that are owned by Bobfr and are currently on). In this example, commands are concatenated to query for virtual machines having multiple property values attributed thereto.

Dir_byState\on\_byOwner\Bobfr\*.vhd

In another example, the following command line can be entered to query for all virtual machines having the property of “Location” with the property value of Boston (e.g., query for all virtual machines in Boston).

Dir_byLocation\Boston\*.vhd

In an example embodiment, the order of concatenated commands can be modified. For example, either of the following command lines can be entered to query for all virtual machines having the property of “State” with the property value of On, and the property of “Owner” with the property value of Bobfr (e.g., query for all virtual machines that are owned by Bobfr and are currently on).

Dir_byState\on\_byOwner\Bobfr\*.vhd

Or

Dir_byOwner\Bobfr\_byState\on\*.vhd

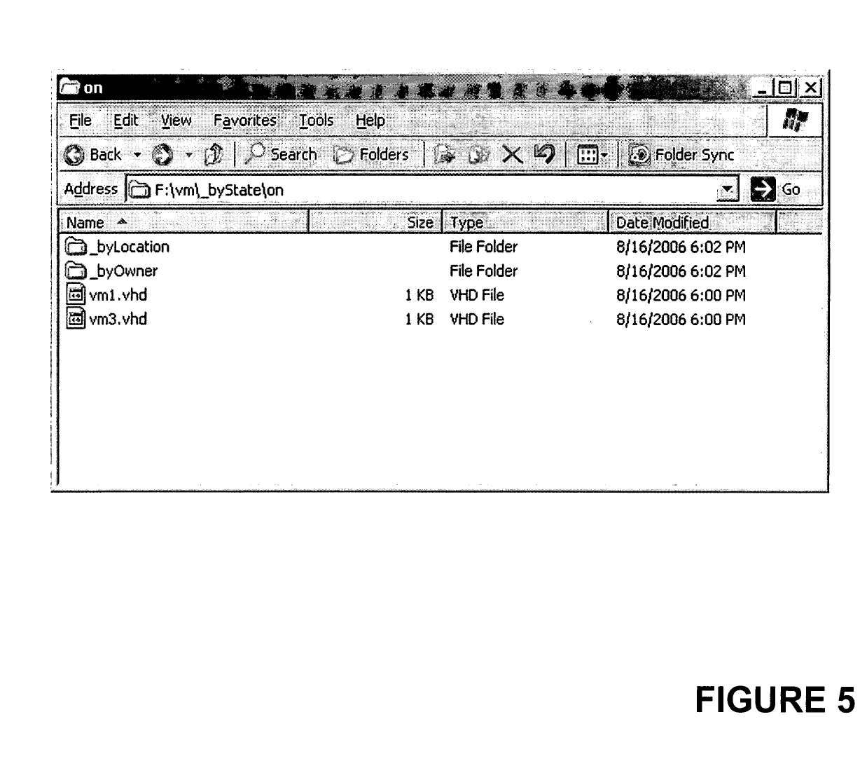

The structures described above rendered in a textual directory can also be rendered via a GUI comprising folders. FIG. 5 is an illustration of an example rendering of a folder representing the property “Location,” a folder representing the property “Owner,” and the virtual machines vm1.vhd and vm2.vhd having a State of On.

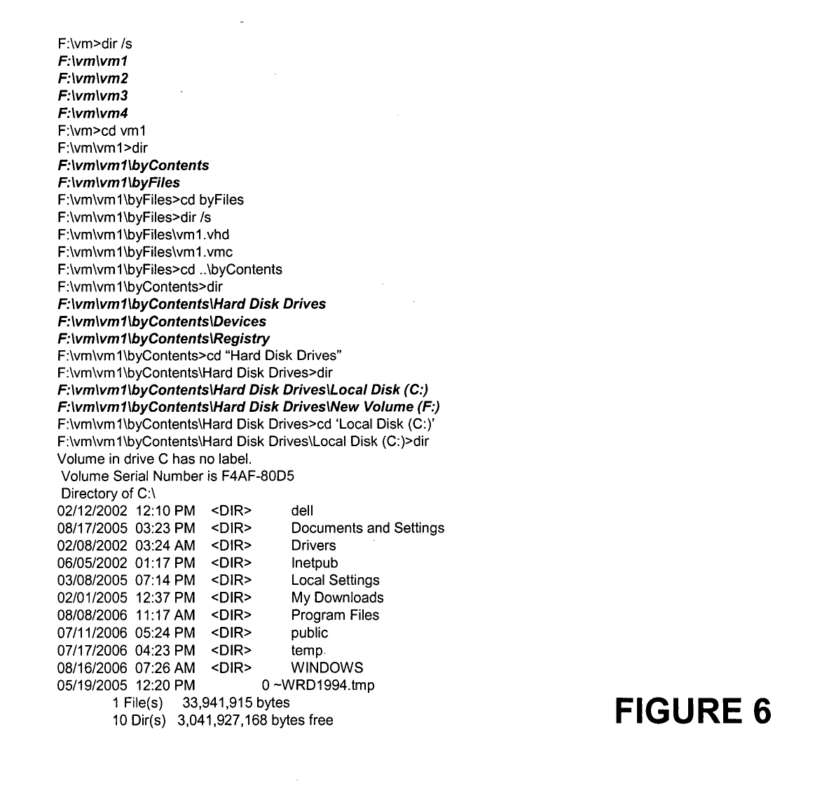

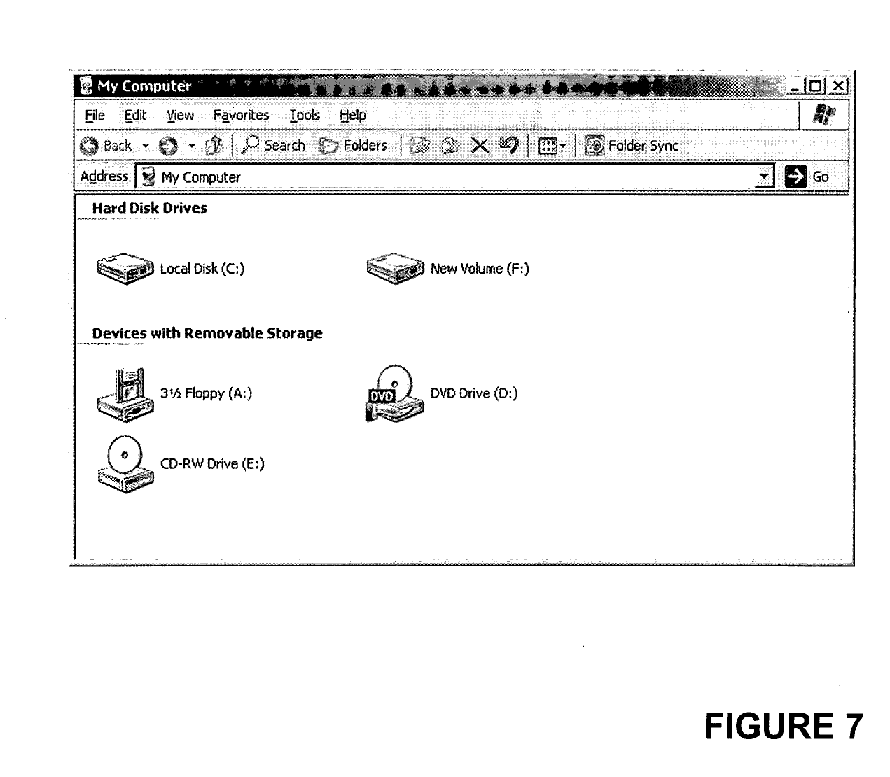

In an example embodiment, a virtual machine can be navigated. That is, the constituents of a virtual machine can be viewed. The constituents can comprise files that a virtual machine comprises and/or devices that a virtual machine comprises. FIG. 6 is a rendering of an example textual hierarchical directory structure showing components of virtual machines. As shown in FIG. 6, components for the virtual machines vm1, vm2, vm3, and vm4, can include files (e.g., vm1.vhd, vm1.vmc), hard disk drives, volumes, devices, registries, or the like, for example. A .vmc file is a virtual machine configuration file, which can represent a virtual machine. In an example embodiment, there is a single .vmc file per VM. In an example embodiment, these structures are renderable via a GUI as depicted in FIG. 7. Selection of an icon/folder results in the ability to navigate that constituent of the virtual machine.

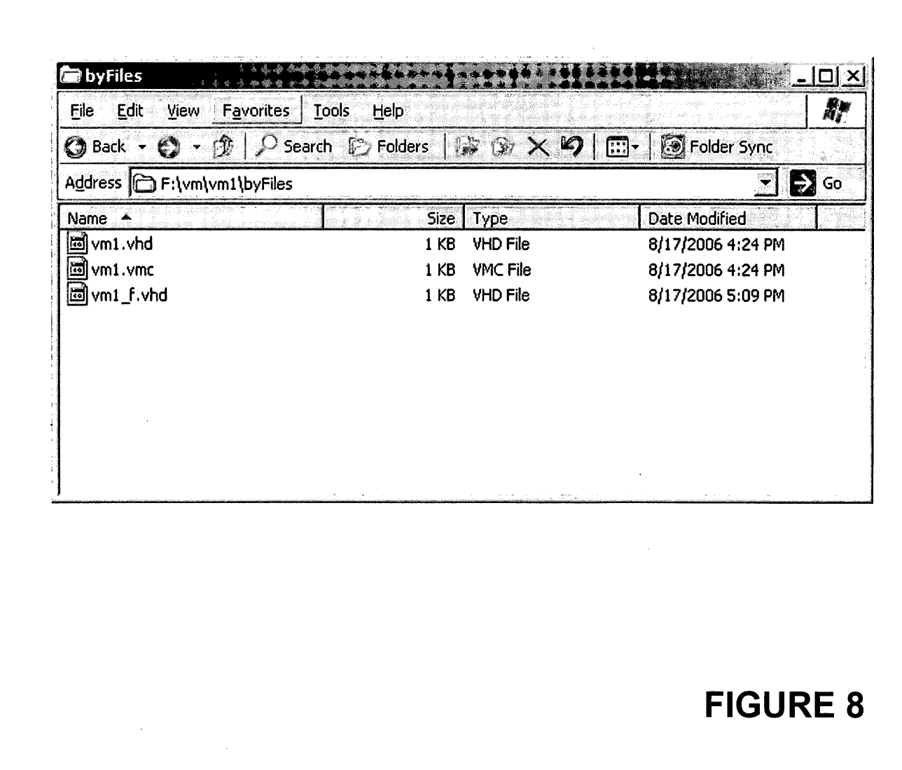

FIG. 8 is an illustration of a GUI rendering, from a host server perspective, of example files comprising a virtual machine in a directory structure. In an example, double clicking the local disk (C:) icon/folder depicted in FIG. 7, or the like, and selecting the \by Files node resulting therefrom, results in viewing all the .vhd files that represent the disk as depicted in FIG. 8.

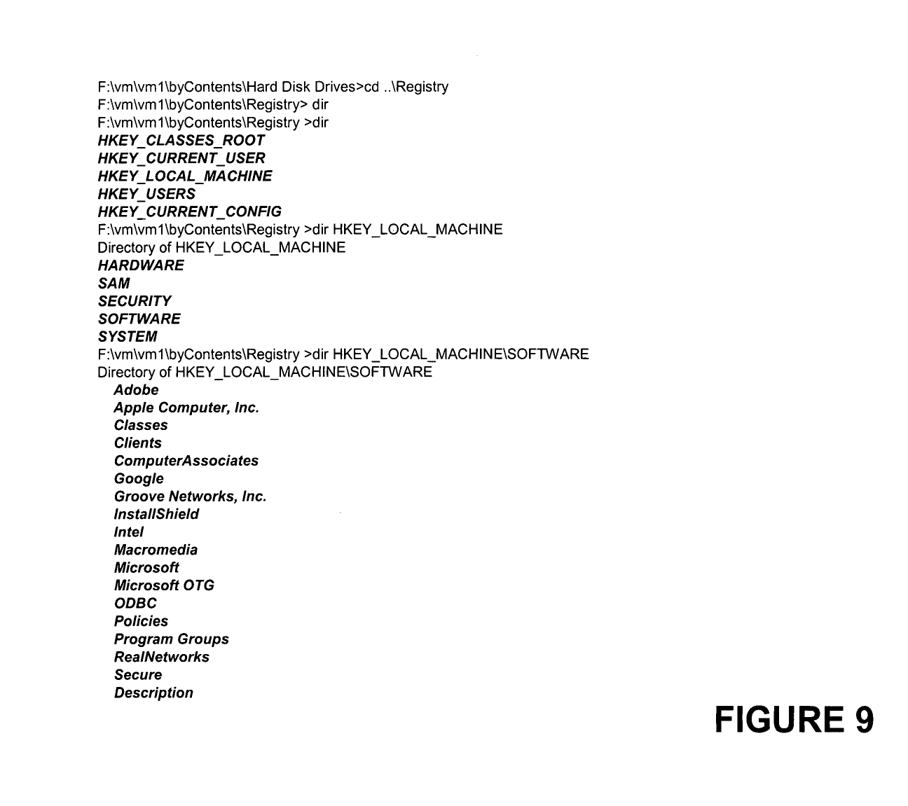

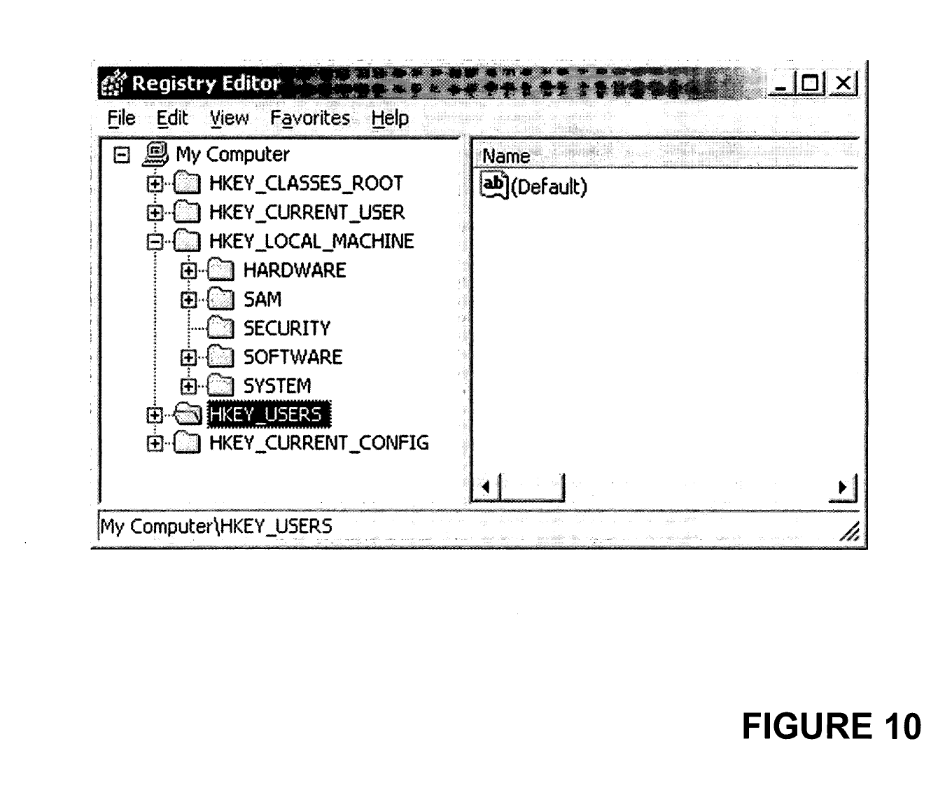

As described above, the registry of a virtual machine is another constituent that can be navigated. In various example embodiments, the registry can be rendered via a textual hierarchical directory structure and/or a GUI comprising folders/subfolders. FIG. 9 is a depiction of a rendering of an example textual hierarchical directory structure of a registry or virtual machine vm1. FIG. 10 is a depiction of a GUT rendering of a registry for a virtual machine.

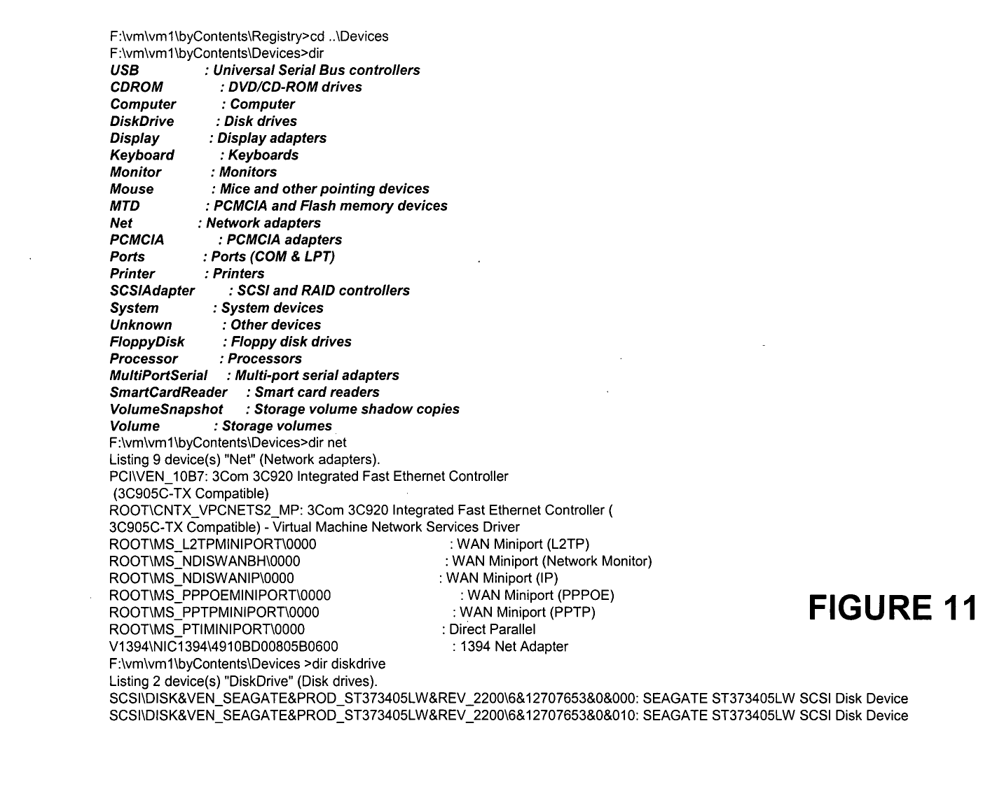

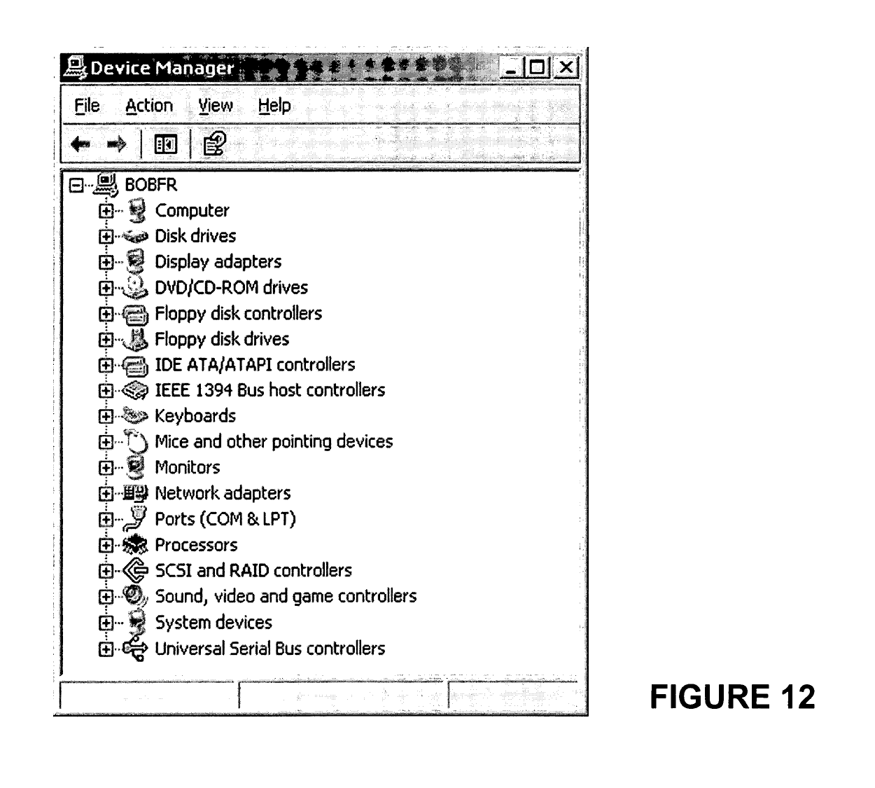

Similarly, devices of a virtual machine can be rendered via a textual hierarchical directory structure and/or a GUT comprising folders/subfolders as depicted in FIG. 11 and FIG. 12, respectively.

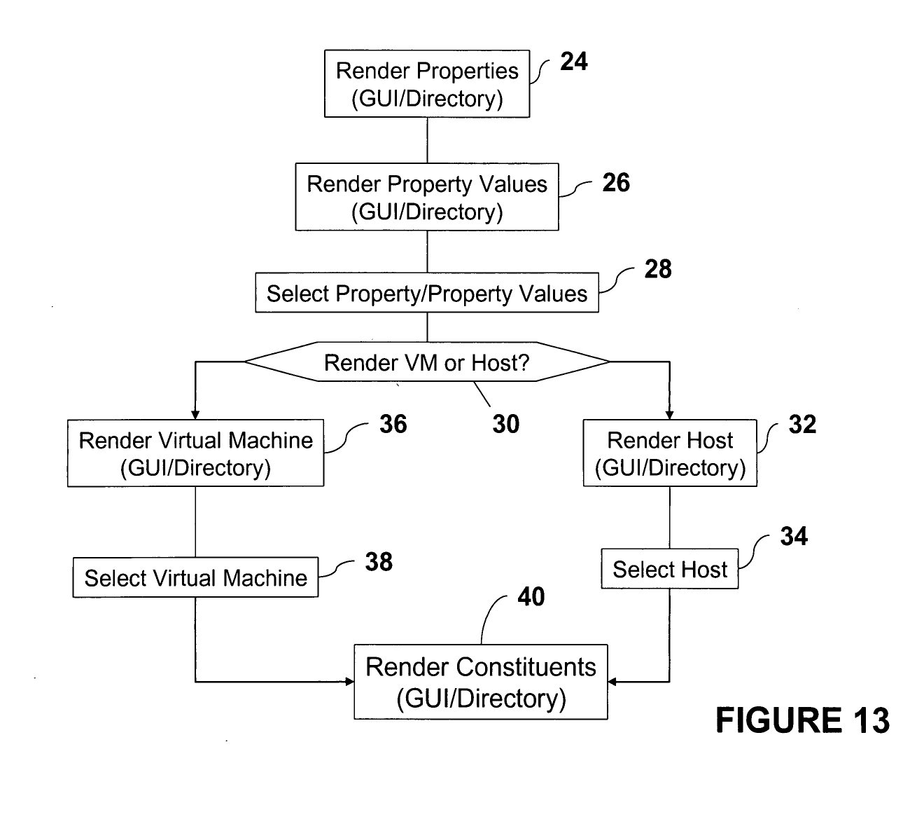

FIG. 13 is a flow diagram of an example process for managing a virtual machine by property. Indications of properties are rendered at step 24. As described above, indications of properties can be rendered via a GUT utilizing a hierarchical structure of folders/subfolders, and/or via a textual hierarchical directory structure. Indications of property values associated with a respective property are rendered at step 26. As described above, indications of property values can be rendered via a GUT utilizing a hierarchical structure of folders/subfolders, and/or via a textual hierarchical directory structure. A property value is selected at step 28. At step 30, it is determined if a virtual machine (VM) or a host is to be rendered. If it is determined (at step 30) that a property value attributable to a virtual machine is to be rendered, an indication of the virtual machine, or virtual machines, having the selected property value attributed thereto is rendered at step 36. As described above, the indication of the virtual machine(s) having the selected property value attributed thereto can be rendered via a GUT utilizing a hierarchical structure of folders/subfolders, and/or via a textual hierarchical directory structure (e.g., via a command-line interpreter). At step 38, a virtual machine is selected. An indication of the constituents of the selected virtual machine is rendered at step 40.

If it is determined (at step 30) a property value attributable to a host is to be rendered, an indication of the host, or hosts, having the selected property value attributed thereto is rendered at step 32. As described above, the indication of the host(s) having the selected property value attributed thereto can be rendered via a GUT utilizing a hierarchical structure of folders/subfolders, and/or via a textual hierarchical directory structure (e.g., via a command-line interpreter). At step 34, a host is selected. An indication of the constituents of the selected host is rendered at step 40. As described above, rendering the indication of the constituents of the selected virtual machine provides the ability to see “inside” the virtual machine. As described above, the indication of the constituents can be rendered via a GUI utilizing a hierarchical structure of folders/subfolders, and/or constituents can be rendered via a textual hierarchical directory structure.

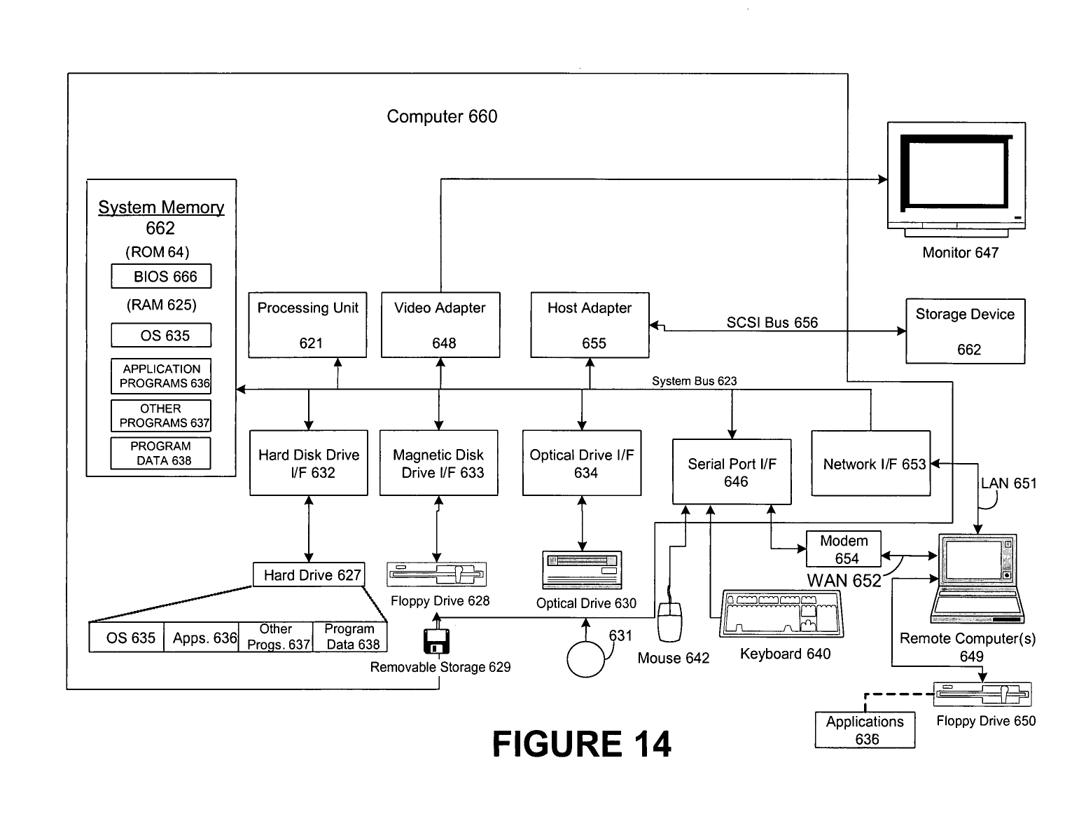

Various embodiments of managing a virtual machine by property are executable on a computing device. FIG. 14 and the following discussion provide a brief general description of a suitable computing environment in which such a computing device can be implemented. Although not required, various aspects of managing a virtual machine by property can be described in the general context of computer executable instructions, such as program modules, being executed by a computer, such as a client workstation or a server. Generally, program modules include routines, programs, objects, components, data structures and the like that perform particular tasks or implement particular abstract data types. Moreover, managing virtual machines and hosts by property can be practiced with other computer system configurations, including hand held devices, multi processor systems, microprocessor based or programmable consumer electronics, network PCs, minicomputers, mainframe computers, and the like. Further, managing a virtual machine by property also can be practiced in distributed computing environments where tasks are performed by remote processing devices that are linked through a communications network. In a distributed computing environment, program modules can be located in both local and remote memory storage devices.

A computer system can be roughly divided into three component groups: the hardware component, the hardware/software interface system component, and the applications programs component (also referred to as the “user component” or “software component”). In various embodiments of a computer system the hardware component may comprise the central processing unit (CPU) 621, the memory (both ROM 664 and RAM 625), the basic input/output system (BIOS) 666, and various input/output (I/O) devices such as a keyboard 640, a mouse 642, a monitor 647, and/or a printer (not shown), among other things. The hardware component comprises the basic physical infrastructure for the computer system.

The applications programs component comprises various software programs including but not limited to compilers, database systems, word processors, business programs, videogames, and so forth. Application programs provide the means by which computer resources are utilized to solve problems, provide solutions, and process data for various users (machines, other computer systems, and/or end-users). In an example embodiment, application programs perform the functions associated with managing a virtual machine by property as described above, such as rendering properties, rendering property values, selecting property values, determining virtual machines and/or hosts having the selected property value(s) attributed thereto, rendering an indication of the virtual machines and/or hosts having the selected property value(s) attributed thereto, selecting a virtual machine, and rendering constituents of the selected virtual machine.

The hardware/software interface system component comprises (and, in some embodiments, may solely consist of) an operating system that itself comprises, in most cases, a shell and a kernel. An “operating system” (OS) is a special program that acts as an intermediary between application programs and computer hardware. The hardware/software interface system component may also comprise a virtual machine manager (VMM), a Common Language Runtime (CLR) or its functional equivalent, a Java Virtual Machine (JVM) or its functional equivalent, or other such software components in the place of or in addition to the operating system in a computer system. A purpose of a hardware/software interface system is to provide an environment in which a user can execute application programs.

The hardware/software interface system is generally loaded into a computer system at startup and thereafter manages all of the application programs in the computer system. The application programs interact with the hardware/software interface system by requesting services via an application program interface (API). Some application programs enable end-users to interact with the hardware/software interface system via a user interface such as a command language or a graphical user interface (GUI).

A hardware/software interface system traditionally performs a variety of services for applications. In a multitasking hardware/software interface system where multiple programs may be running at the same time, the hardware/software interface system determines which applications should run in what order and how much time should be allowed for each application before switching to another application for a turn. The hardware/software interface system also manages the sharing of internal memory among multiple applications, and handles input and output to and from attached hardware devices such as hard disks, printers, and dial-up ports. The hardware/software interface system also sends messages to each application (and, in certain case, to the end-user) regarding the status of operations and any errors that may have occurred. The hardware/software interface system can also offload the management of batch jobs (e.g., printing) so that the initiating application is freed from this work and can resume other processing and/or operations. On computers that can provide parallel processing, a hardware/software interface system also manages dividing a program so that it runs on more than one processor at a time.

A hardware/software interface system shell (referred to as a “shell”) is an interactive end-user interface to a hardware/software interface system. (A shell may also be referred to as a “command interpreter” or, in an operating system, as an “operating system shell”). A shell is the outer layer of a hardware/software interface system that is directly accessible by application programs and/or end-users. In contrast to a shell, a kernel is a hardware/software interface system's innermost layer that interacts directly with the hardware components.

As shown in FIG. 14, an exemplary general purpose computing system includes a conventional computing device 660 or the like, including a processing unit 621, a system memory 662, and a system bus 623 that couples various system components including the system memory to the processing unit 621. The system bus 623 may be any of several types of bus structures including a memory bus or memory controller, a peripheral bus, and a local bus using any of a variety of bus architectures. The system memory includes read only memory (ROM) 664 and random access memory (RAM) 625. A basic input/output system 666 (BIOS), containing basic routines that help to transfer information between elements within the computing device 660, such as during start up, is stored in ROM 664. The computing device 660 may further include a hard disk drive 627 for reading from and writing to a hard disk (hard disk not shown), a magnetic disk drive 628 (e.g., floppy drive) for reading from or writing to a removable magnetic disk 629 (e.g., floppy disk, removal storage), and an optical disk drive 630 for reading from or writing to a removable optical disk 631 such as a CD ROM or other optical media. The hard disk drive 627, magnetic disk drive 628, and optical disk drive 630 are connected to the system bus 623 by a hard disk drive interface 632, a magnetic disk drive interface 633, and an optical drive interface 634, respectively. The drives and their associated computer readable media provide non volatile storage of computer readable instructions, data structures, program modules and other data for the computing device 660. Although the exemplary environment described herein employs a hard disk, a removable magnetic disk 629, and a removable optical disk 631, it should be appreciated by those skilled in the art that other types of computer readable media which can store data that is accessible by a computer, such as magnetic cassettes, flash memory cards, digital video disks, Bernoulli cartridges, random access memories (RAMs), read only memories (ROMs), and the like may also be used in the exemplary operating environment. Likewise, the exemplary environment may also include many types of monitoring devices such as heat sensors and security or fire alarm systems, and other sources of information.

A number of program modules can be stored on the hard disk, magnetic disk 629, optical disk 631, ROM 664, or RAM 625, including an operating system 635, one or more application programs 636, other program modules 637, and program data 638. A user may enter commands and information into the computing device 660 through input devices such as a keyboard 640 and pointing device 642 (e.g., mouse). Other input devices (not shown) may include a microphone, joystick, game pad, satellite disk, scanner, or the like. These and other input devices are often connected to the processing unit 621 through a serial port interface 646 that is coupled to the system bus, but may be connected by other interfaces, such as a parallel port, game port, or universal serial bus (USB). A monitor 647 or other type of display device is also connected to the system bus 623 via an interface, such as a video adapter 648. In addition to the monitor 647, computing devices typically include other peripheral output devices (not shown), such as speakers and printers. The exemplary environment of FIG. 14 also includes a host adapter 655, Small Computer System Interface (SCSI) bus 656, and an external storage device 662 connected to the SCSI bus 656.

The computing device 660 may operate in a networked environment using logical connections to one or more remote computers, such as a remote computer 649. The remote computer 649 may be another computing device (e.g., personal computer), a server, a router, a network PC, a peer device, or other common network node, and typically includes many or all of the elements described above relative to the computing device 660, although only a memory storage device 650 (floppy drive) has been illustrated in FIG. 14. The logical connections depicted in FIG. 14 include a local area network (LAN) 651 and a wide area network (WAN) 652. Such networking environments are commonplace in offices, enterprise wide computer networks, intranets and the Internet.

When used in a LAN networking environment, the computing device 660 is connected to the LAN 651 through a network interface or adapter 653. When used in a WAN networking environment, the computing device 660 can include a modem 654 or other means for establishing communications over the wide area network 652, such as the Internet. The modem 654, which may be internal or external, is connected to the system bus 623 via the serial port interface 646. In a networked environment, program modules depicted relative to the computing device 660, or portions thereof, may be stored in the remote memory storage device. It will be appreciated that the network connections shown are exemplary and other means of establishing a communications link between the computers may be used.

While it is envisioned that numerous embodiments of managing virtual machines and hosts by property are particularly well-suited for computerized systems, nothing in this document is intended to limit the invention to such embodiments. On the contrary, as used herein the term “computer system” is intended to encompass any and all devices capable of storing and processing information and/or capable of using the stored information to control the behavior or execution of the device itself, regardless of whether such devices are electronic, mechanical, logical, or virtual in nature.

The various techniques described herein can be implemented in connection with hardware or software or, where appropriate, with a combination of both. Thus, the methods and apparatuses for managing virtual machines and hosts by property, or certain aspects or portions thereof, can take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for managing virtual machines and hosts by property.

The program(s) can be implemented in assembly or machine language, if desired. In any case, the language can be a compiled or interpreted language, and combined with hardware implementations. The methods and apparatuses for managing virtual machines and hosts by property also can be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes an apparatus for managing virtual machines and hosts by property. When implemented on a general-purpose processor, the program code combines with the processor to provide a unique apparatus that operates to invoke the functionality of managing virtual machines and hosts by property. Additionally, any storage techniques used in connection with managing virtual machines and hosts by property can invariably be a combination of hardware and software.

Managing virtual machines and hosts by property as described herein provides dynamic and static organization of virtual machines into folders and subfolders based on specific properties of the virtual machines and/or hosts. Also provided is an association of a graphical representation, such as an icon, to a search folder and subfolders that may be either common or distinct from other search folders and sub-folders. The search folder concept can be used to browse virtual machines and hosts by property. Users have the ability to generate and save new search folders based on current views or provided search criteria. Users also have the ability to define which properties, including any custom property extensions to the objects, should be shown as “By Property” nodes. A hierarchy of “By Property” folders can be generated specifying the order of the properties (e.g., by owner, by state, by location). Virtual infrastructure objects can be dynamically organized into folders based on specific properties of the virtual infrastructure objects. The search folder concept can be used to create “By Property” browsing of virtual infrastructure object in a library. Tasks can by dynamically organized into folders based on specific properties of the virtual infrastructure objects. Search folder can be used to create “By Property” browsing tasks.

While managing virtual machines and hosts by property has been described in connection with the example embodiments of the various figures, it is to be understood that other similar embodiments can be used or modifications and additions can be made to the described embodiments for performing the same functions for managing virtual machines and hosts by property without deviating therefrom. Therefore, managing virtual machines and hosts by property as described herein should not be limited to any single embodiment, but rather should be construed in breadth and scope in accordance with the appended claims.

What is claimed:

1. A method for managing a plurality of virtual machines, the method comprising:
rendering a representation of a plurality of properties and respective property values, each property and property value being attributable to one of a virtual machine and a host of a virtual machine;
receiving an indication of at least one selected property value, wherein the at least one selected property value was selected from the rendered plurality of properties values; and
rendering an indication of one of each virtual machine and each host having attributed thereto the at least one selected property value.

2. A method in accordance with claim 1 further comprising dynamically updating at least one of a property and a property value associated with each virtual machine and each host.

3. A method in accordance with claim 1, further comprising:
visually rendering folders and subfolders to represent the plurality of properties and property values, wherein:
a folder is indicative of a property; and
a subfolder of a folder is indicative of a property value of a respective folder.

4. A method in accordance with claim 1 wherein:
rendering a representation of the plurality of properties and associated property values comprises rendering a respective icon for each property and associated property value; and
rendering an indication of each virtual machine of the plurality of virtual machines having the at least one selected property value comprises rendering a respective icon for each virtual machine of the plurality of virtual machines having the selected at least one property value.

5. A method in accordance with claim 1, further comprising:
visually rendering at least one of a textual directory structure and a graphic user interface directory structure to represent the plurality of properties and associated property values; and
visually rendering at least one of a textual directory structure and a graphic user interface directory structure to represent an indication of each virtual machine and each host having the at least one selected property value.

6. A method in accordance with claim 1 wherein, a property comprises at least of a geographic location, an organizational structure, an owner, a state, a creation date, a search result, and an operating system.

7. A method in accordance with claim 1, further comprising:
selecting a virtual machine of the plurality of virtual machines; and
rendering an indication of constituents of the selected a virtual machine, wherein the constituents comprise at least one of:
at least one file of the selected virtual machine; and
at least one device of the selected virtual machine.

8. A method in accordance with claim 1, further comprising performing at least one of adding a property, deleting a property, modifying a property, adding a property value, deleting a property value, modifying a property value, adding a virtual machine, deleting a virtual machine, modifying a virtual machine, adding a host, deleting a host, and modifying a host.

9. A system for managing a plurality of virtual machines, the system comprising:
an input/output portion configured to:
render a representation of a plurality of properties and respective property values, wherein:
each property is attributable to one of a virtual machine and a host of a virtual machine; and
render an indication of each virtual machine and each host having attributed thereto at least one selected property value; and
a processing portion configured to:
receive an indication of the at least one selected property value, wherein the at least one selected property value was selected from the rendered plurality of property values; and
determine if at least one of a virtual machine and a host has attributed thereto the at least one selected property value.

10. A system in accordance with claim 9, the processing portion further configured to dynamically update at least one of a property and a property value associated with each virtual machine and each host.

11. A system in accordance with claim 9, the input/output portion further configured to:
visually render folders and subfolders to represent the plurality of properties and property values, wherein:
a folder is indicative of a property; and
a subfolder of a folder is indicative of a property value of a respective folder.

12. A system in accordance with claim 9 wherein:
rendering a representation of the plurality of properties and associated property values comprises rendering a respective icon for each property and associated property value; and
rendering an indication of each virtual machine and each host having the selected property value comprises rendering a respective icon for each virtual machine and for each host having the selected property value.

13. A system in accordance with claim 9, the input/output portion further configured to:
visually render at least one of a textual directory structure and a graphic user interface directory structure to represent the plurality of properties and associated property values; and
visually render at least one of a textual directory structure and a graphic user interface directory structure to represent indication of each virtual machine and each host having the selected property value.

14. A system in accordance with claim 9 wherein, a property comprises at least of a geographic location, an organizational structure, an owner, a state, a creation date, a search result, and an operating system.

15. A system in accordance with claim 9, the input/output portion further configured to render an indication of constituents of a selected virtual machine of the plurality of virtual machines, wherein a constituent comprises at least one of:
at least one file of the selected virtual machine; and
at least one device of the selected virtual machine.

16. A system in accordance with claim 9, the processor portion further configured to perform at least one of adding a property, deleting a property, modifying a property, adding a property value, deleting a property value, modifying a property value, adding a virtual machine, deleting a virtual machine, and modifying a virtual machine, adding a host, deleting a host, and modifying a host.

17. A computer-readable medium having stored thereon computer-executable instruction for managing a plurality of virtual machines, the computer-executable instructions for:
rendering a representation of a plurality of properties and respective property values, each property and property value being attributable to one of a virtual machine and a host of a virtual machine;
receiving an indication of at least one selected property value, wherein the at least one selected property value was selected from the rendered plurality of properties values;
rendering an indication of one of each virtual machine and each host having attributed thereto the at least one selected property value; and
visually rendering folders and subfolders to represent the plurality of properties and property values, wherein:
a folder is indicative of a property; and
a subfolder of a folder is indicative of a property value of a respective folder.

18. A computer-readable medium of claim 17, the computer-executable instructions further for dynamically updating at least one of a property and a property value associated with each virtual machine and each host.

19. A computer-readable medium of claim 17, the computer-executable instructions further for:
visually rendering at least one of a textual directory structure and a graphic user interface (GUI) directory structure to represent the plurality of properties and associated property values; and
visually rendering at least one of a textual directory structure and a GUI directory structure to represent an indication of each virtual machine and each host having the at least one selected property value, wherein:
rendering, via a GUI, a representation of the plurality of properties and associated property values comprises rendering a respective icon for each property and associated property value; and
rendering, via a GUI, an indication of each virtual machine of the plurality of virtual machines having the at least one selected property value comprises rendering a respective icon for each virtual machine of the plurality of virtual machines having the selected at least one property value.

20. A computer-readable medium in accordance with claim 17, the computer-executable instructions further for:
performing at least one of adding a property, deleting a property, modifying a property, adding a property value, deleting a property value, modifying a property value, adding a virtual machine, deleting a virtual machine, modifying a virtual machine, adding a host, deleting a host, and modifying a host, wherein a property comprises at least of a geographic location, an organizational structure, an owner, a state, a creation date, and an operating system.
